(19) United States
(12) Patent Application Publication
(10) Pub. No.: US 2013/0114843 A1
(43) Pub. Date: May 9, 2013

(54) EARPHONE JACK FOR USE WITH EAR PHONE PLUGS OF DIFFEREING DIAMETER AND ELECTRONIC DEVICE USING THE SAME

(71) Applicant: Jian-Hui LI, Shenzhen City (CN)

(72) Inventor: Jian-Hui LI, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/597,586

(22) Filed: Aug. 29, 2012

(30) Foreign Application Priority Data
Nov. 4, 2011 (CN) 201110345363.5

(51) Int. Cl. H04R 1/10

(52) U.S. Cl. 381/384

(57) ABSTRACT

An earphone jack includes a main body, a number of guiding plates, at least one positioning plate, a number of blades, and a frame. The main body defines a hole. The guiding plates surround the hole, and the positioning plate is formed on the guiding plates. The blades rotatably engage with the guiding plates. The frame is mounted with the blades. When the frame is rotated, the blades moves along the guiding plates to allow the blades to provide different latching spaces for receiving different sizes earphone plugs.

### BACKGROUND

1. Technical Field

The present disclosure generally relates to earphone jacks, and particularly, to an earphone jack for use in an electronic device.

2. Description of Related Art

Electronic devices, such as mobile phones, computers have an earphone jack. An earphone plug can be inserted into the earphone jack to transfer sound frequency signals to an earphone/headphone.

However, conventional earphone plugs include two types, e.g. 2.5 mm diameter and 3.5 mm diameter. The 2.5 mm diameter of the earphone plug is used in the mobile phones, and the 3.5 mm diameter of the earphone plug is used in the computer. Consumers cannot use different kinds of earphones in the same electronic device. It can be inconvenient for consumers.

Therefore, there is a room for improvement within the art.

### BRIEF DESCRIPTION OF THE DRAWINGS

Many aspects of the earphone jack and electronic device using the same can be better understood with reference to the following drawings. The components in the drawings are not necessarily to scale, the emphasis instead being placed upon clearly illustrating the earphone jack and electronic device using the same. Moreover, in the drawings, like reference numerals designate corresponding parts throughout the several views.

FIG. 1 is an isometric view of an earphone jack into which an earphone plug is plugged.

FIG. 2 is a disassembly isometric view of the earphone jack and the earphone shown in FIG. 1.

FIG. 3 is an exploded, isometric view of the earphone jack.

FIG. 4 is a plan view of the guiding plates arranged on the earphone jack.

FIG. 5 is a partially assembled view of the earphone jack shown in FIG. 4.

FIG. 6 is a partially assembled view of the earphone jack omitting the guiding plates.

FIG. 7 is a cross-sectional view of FIG. 1 taken along line VII-VII.

FIG. 8 is a cross-sectional view of FIG. 1 taken along line VII-VII when another size earphone plug is plugged into the earphone jack.

### DETAILED DESCRIPTION

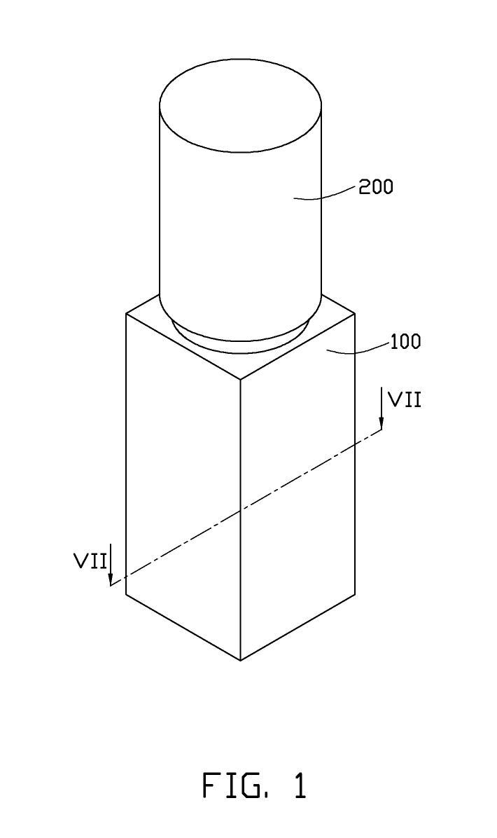

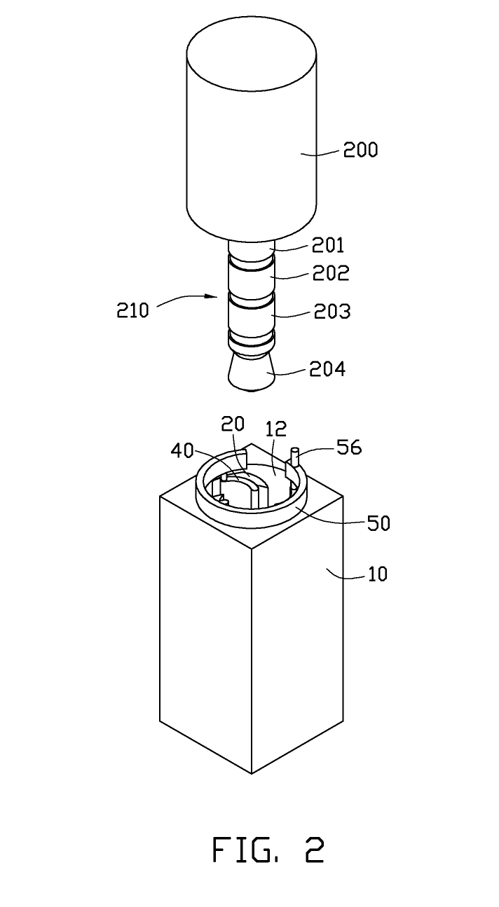

FIGS. 1 and 2 show an earphone jack 100 engaging with an earphone 200 according to an exemplary embodiment. The earphone jack 100 can be installed in a portable electronic device, such as a mobile phone or a computer, to convert electrical signals provided thereby into audio signals. The earphone 200 includes a cylindrical plug 210 with a first contact 201, a second contact 202, a third contact 203 and a fourth contact 204 for respectively electronically connecting the earphone jack 100. In this exemplary embodiment, the diameter of the cylindrical plug 210 is 3.5 mm.

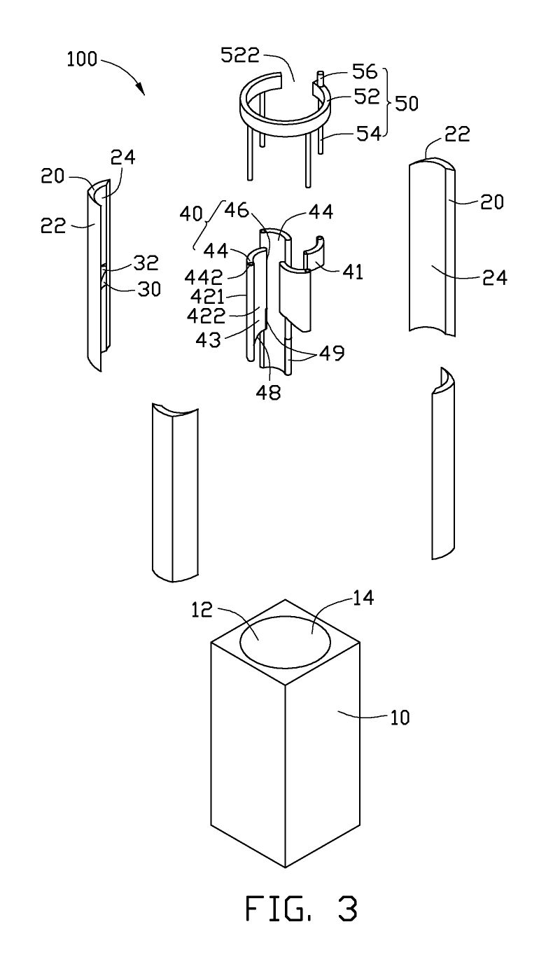

Referring to FIG. 3, the earphone jack 100 includes a main body 10, a plurality of guiding plates 20, at least one positioning plate 30, a plurality of blades 40, and a frame 50. The guiding plates 20 are mounted to the main body 10, and are configured for engaging with the blades 40 to guide the movement of the blades 40. The positioning plate 30 is used for limiting the blades 40 at a predetermined position. The frame 50 is configured for rotating the blades 40 along the guiding plates 20.

The main body 10 may be an independent element, or may be one part of the portable electronic device. The main body 10 includes an earphone hole 12 surrounded by a ring-like peripheral wall 14.

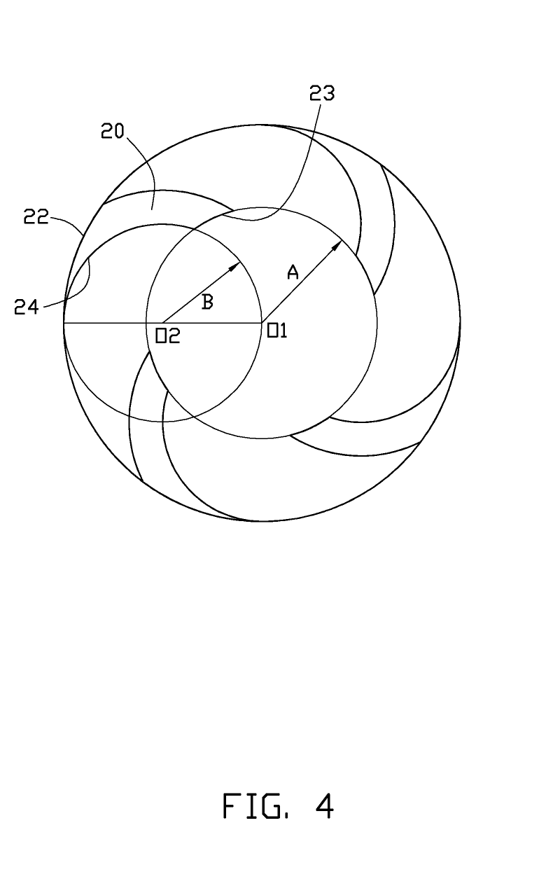

The guiding plates 20 are attached to the peripheral wall 14, and are centered with the earphone hole 12. In the exemplary embodiment, there are four guiding plates 20. Referring to FIG. 4, each guiding plate 20 is an arcuate plate, and includes a first end surface 22, a second end surface 23, and an inner guiding surface 24. The first end surface 22 is mounted to the peripheral wall 14 for mounting each guiding plate 20 to the peripheral wall 14. Each second end surface 23 is arcuate. The second end surfaces 23 of the guiding plates 20 are arranged on a circle A having a center O1 for receiving the earphone plug 200. Each inner guiding surface 24 is arcuate, and is one part of a circle B having a center O2. The circle B extends though the center O1 of the circle A.

The positioning plates 30 are mounted to the inner guiding surfaces 24 of the guiding plates 20. In the exemplary embodiment, there are three positioning plates 30. The positioning plates 30 are mounted to the inner guiding surfaces 24 of three of the guiding plates 20. Each positioning plate 30 includes a stopper surface 32 at one end thereof.

The blades 40 are positioned on the guiding plates 24, and can rotate along the guiding surfaces 24. A length of each blade 40 depends on the length and height of its respective contacts 201, 202, 203, 204 on the plug 210. In the exemplary embodiment, the blades 40 include a first blade 41, a second blade 42, a third blade 43 and a fourth blade 44. The lengths of the first blade 41, the second blade 42, the third blade 43 and the fourth blade 44 respectively correspond to the first contact 201, the second contact 202, the third contact 203 and the fourth contact 204 for electronically connecting the first contact 201, the second contact 202, the third contact 203 and the fourth contact 204. Each blade 40 includes a first surface 421, a second surface 422, a mounting end 44, a mating end 48, and a resisting end 46. The shape of the first surface 421 mates with the inner guiding surface 24, and the mating end 48 slidably abuts against the stopper surface 32 of each positioning plate 30. The mounting end 44 defines a latching hole 442 for mounting with the frame 50. When the blades 40 are rotated relative to the guiding surfaces 24, the mating end 48 of the blades 40 will move on the stopper surfaces 32. The stopper surfaces 32 can limit the blades 40 at a predetermined position relative to the guiding plates 20. A conductive contact 49 is formed on the resisting end 46 of each blade 40 for electrically abutting against one of the first contact 201, the second contact 202, the third contact 203 and the fourth contact 204 of the earphone plug 210.

The frame 50 is made of elastic material, and includes a ring portion 52, and a plurality of poles 54 and an operating rod 56. The ring portion 52 defines an opening 522. The poles 54 extend from one side of the ring portion 52, and are parallel with each other. The length of the poles 54 correspond to the length of the blades 41, 42, 43, 44, and are configured for mounting in the latching holes 442. The operating rod 56 extends from another side of the ring portion 52 for driving the frame 50 to rotate in the earphone hole 14.

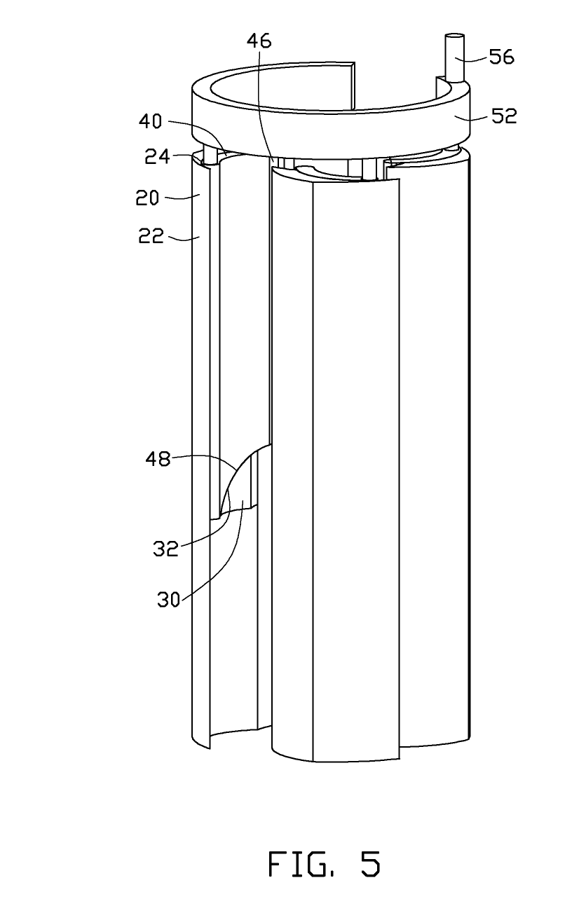

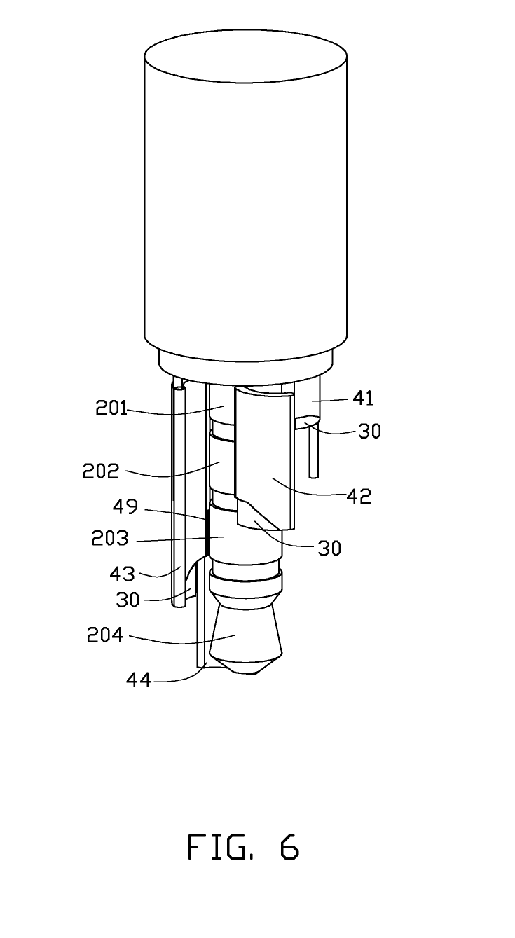

In assembly, referring to FIGS. 5 and 6, the positioning plates 30 are mounted to the inner guiding surface 24 of the guiding plates 20. The positions of the positioning plates 30 are configured for abutting against the blades 40. Then, the guiding plates 20 are adhered to the peripheral wall 14. The poles 54 are inserted into the latching holes 442 to assemble the blades 40 on the frame 50. After that, the frame 50 with the blades 40 are placed into the earphone hole 12 until the mating ends 48 abut against the stopper surfaces 32.

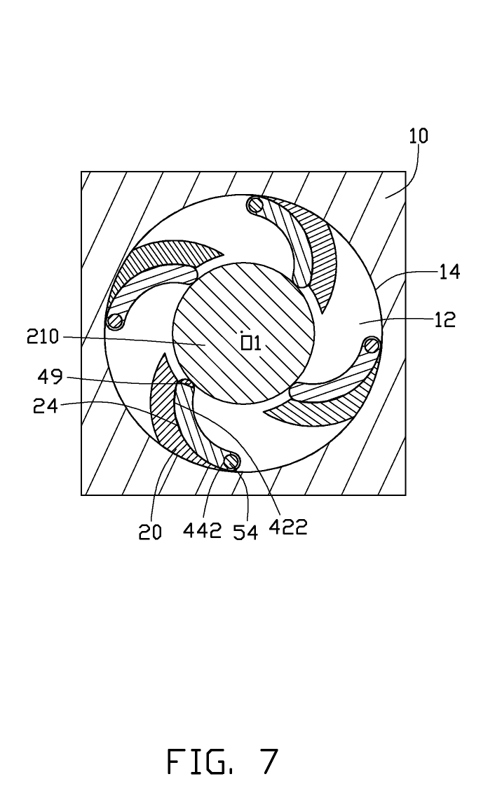

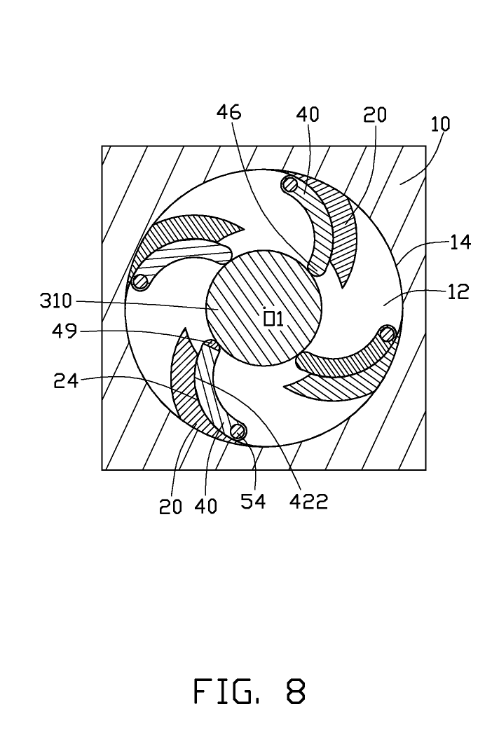

Referring to FIG. 7, the blades 40 abut against the earphone plug 210. Referring to FIG. 8, when another size of earphone plug 310, e.g. 2.5 mm diameter, is inserted into the space, the user only rotate the operating rod 56 along the hole 12 to rotate the frame 50, the poles 54 of the frame 50 moves the blades 40 along the guiding plates 20 and the stopper surfaces 32, the blades 40 will move toward the center O1 of the hole 12. When the blades 40 slide to a predetermined position, the blades 40 are kept in that position because of the role of the positioning plates 30. Thus, the blades 40 define a differently sized space to receive a corresponding sized earphone plug 310.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An earphone jack comprising:
a main body defining a hole;
a plurality of guiding plates inside the main body and surrounding the hole, at least one positioning plate formed on the guiding plates;
a plurality of blades rotatably engaging with the guiding plates;
a rotatable frame, the blades mounted on the frame;
wherein when the frame is rotated, the blades moves along their respective guiding plates to allow the blades to provide different sized latching spaces for receiving different sized earphone plugs.

2. The earphone jack as claimed in claim 1, wherein each guiding plate includes a first end surface, a second end surface, a guiding surface, the second end surfaces of the guiding plates are arranged on a first circle, each inner guiding surface forming part of a second circle extending though the center of the first circle.

3. The earphone jack as claimed in claim 2, wherein the at least one positioning plate is mounted to one of the inner guiding surfaces, each positioning plate includes a stopper surface at one end thereof, each blade includes a first surface, a second surface, and a mating end, the shape of the first surfaces mates with the guiding surface, and the mating end slidably abuts against the stopper surface of the at least one positioning plate.

4. The earphone jack as claimed in claim 3, wherein each blade includes a mounting end defining a latching hole, the frame includes a plurality of poles, the poles are parallel with each other and are latched in the latching holes.

5. The earphone jack as claimed in claim 4, wherein the frame includes a ring portion, and an operating rod, the poles extend from one side of the ring portion, the operating rod extends from another side of the ring portion.

6. An electronic device, comprising:
an earphone including an earphone plug;
an earphone jack comprising a plurality of guiding plates and a plurality of blades rotatably engaging with the guiding plates, the blades defining a first sized receiving space; and
a rotatable frame, the blades mounted on the frame;
wherein when the frame is rotated, the blades move along their respective guiding plates to define a second sized receiving space to receive a different sized earphone plug.

7. The electronic device as claimed in claim 6, wherein each guiding plate includes a first end surface, a second end surface, a guiding surface, the second end surfaces of the guiding plates are arranged on a first circle, each inner guiding surface forming part of a second circle extending though the center of the first circle.

8. The electronic device as claimed in claim 7, further comprising at least one positioning plate, wherein the at least one positioning plate is mounted to one of the inner guiding surfaces, each positioning plate includes a stopper surface at one end thereof, each blade includes a first surface, a second surface, and a mating end, the shape of the first surfaces mates with the guiding surface, and the mating end slidably abuts against the stopper surface of the at least one positioning plate.

9. The electronic device as claimed in claim 8, wherein each blade includes a mounting end defining a latching hole, the frame includes a plurality of poles, the poles are parallel with each other and are latched in the latching holes.

10. The electronic device as claimed in claim 9, wherein the frame includes a ring portion, and an operating rod, the pole extends from one side of the ring portion, the operating rod extends from another side of the ring portion.
